(19) United States
(12) Patent Application Publication
(10) Pub. No.: US 2004/0146842 A1
(43) Pub. Date: Jul. 29, 2004

(54) Training device for the respiratory system

(76) Inventors: Lucio Carlucci, Wetzikon (CH); Wolfgang Nikolaus Nutt, Balzers (LI); Tobis-Lukas Vogel, Weinfelden (CH); Hans-Jorg Zweifel, Unterengstringen (CH)

Correspondence Address: NOTARO AND MICHALOS, 100 DUTCH HILL ROAD, SUITE 110, ORANGEBURG, NY, 10962-2100, US

(21) Appl. No.: 10/473,544

(22) PCT Filed: Apr. 8, 2002
(86) PCT No.: PCT/CH02/00194

(30) Foreign Application Priority Data
Apr. 10, 2001 (CH) 673/01

(51) Int. Cl. G09B 23/28

(52) U.S. Cl. 434/262

(57) ABSTRACT

The respiratory training device comprises a shell housing (1) with a detachable respiratory air channel (2) connected therewith, a mouthpiece (3), an air bag (5) and a control device (14). In the respiratory air channel (2) a valve configuration is installed and specifically a piston valve. This piston valve is equipped with a valve body, which is freely movable and does not have a fixed connection to the respiratory air channel (2). In the housing part (1) and/or in the housing of the valve configuration force-generating means are available, which retain the valve body in the sealing position and determine the necessary opening forces for the valve. All parts, which are in contact with respiratory air, can be removed and cleaned simply.

The invention relates to a training device for respiratory function with a mouthpiece, a respiratory air channel terminating at the mouthpiece, with an inlet/outlet opening for air, a flexible air bag connected to the respiratory air channel and a valve configuration for regulating the outlet quantity of consumed air from the respiratory channel and the inlet quantity of fresh air into the respiratory air channel as well as a method for operating such a device.

Training devices of this type serve for strengthening the muscles of respiration. This can serve, on the one hand, for therapeutic purposes, but, on the other hand, healthy persons can also improve respiratory functions and increase the respiratory performance. The latter is of interest, for example, with persons active in sports. Devices of this type are known for example from WO 9917842.

The device described in WO 9917842 comprises a tubular respiratory air channel, which is provided at one end with a mouthpiece. At the end facing away from the mouthpiece of the respiratory air channel it is branched, with a subpiece of the channel leading into a flexible bag and being connected to it. The second branch of the respiratory air channel is connected with a valve configuration via which consumed air can flow out of the respiratory air channel or fresh air can be drawn into the respiratory air channel. The valve configuration is a flexible tongue valve (reed type) which opens at a predetermined underpressure and makes possible drawing in fresh air through the respiratory air channel. The valve closes at normal pressure in the respiratory air channel and, for the remainder, is developed such that, upon a predetermined overpressure having been reached in the respiratory air channel, it opens again and makes possible for consumed respiratory air to flow out of the respiratory air channel into the environment. The basic function of the prior known training device consists in that a person utilizing the device breathes only via the mouthpiece and consequently the training device. With each respiratory cycle, a portion of the exhaled air is stored in the bag and only when it is full, does the valve open due to the developed overpressure, and the residual volume is exhaled via the valve. When changing the exhalation process to the inhalation process, the valve closes and the person breathing via the mouthpiece breathes first the entire content of the bag volume. Only when the bag is empty does the desired underpressure develop in the respiratory air channel and the valve opens again and makes possible the additional inhalation of fresh air. The volume of the bag connected to the respiratory air channel is determined specific as to the individual person. The prior known device furthermore comprises a control device, which indicates the frequency at which breathing is to take place and a control/checking device for monitoring the CO₂ content in the respiratory air. During the course of the training, the CO₂ content in the respiratory air should remain constant within a predetermined range which is not harmful to health. The component parts of the training device through which the respiratory air flows, are contaminated with each training process and it must be possible for them to be cleaned. The affected parts must be sterilized, especially in the case of a therapeutic application of the device. In the prior known devices, these processes are difficult to carry out, especially the cleaning of the valve configuration is difficult and entails considerable expenditures.

The present invention addresses the problem of providing a training device for the respiratory function which is simple in structure, in which the moving parts and those in contact with respiratory air can be removed without auxiliary means, the parts of the device coming into contact with respiratory air are sterilizable if needed, and in which the valve configuration or the function of the valve is to the greatest possible extent independent of the position of the valve.

This problem is solved through the characteristics defined in patent claim 1 and patent claim 20. Advantageous further developments of the invention are evident based on the characteristics of the dependent patent claims.

The use according to the invention of a piston valve in the valve configuration leads to several advantages. The housing part of the piston valve can form an integral component of the respiratory air channel and the valve body can be disposed and guided directly in the interior of the respiratory air channel. Thereby an optimal flow of the respiratory air in the direction of the flow axis in the air passage volume of the respiratory air channel and of the valve housing part is ensured. The valve body comprises a piston which fits tightly against a sealing face on the air passage volume and is slidingly guided in the air passage volume and displaceable in both directions of the flow axis. The valve body has no mechanical connections to the housing part of the piston valve, but rather additional force-generating means are available, which position the valve body relative to the housing part of the piston valve in the sealing position. These force-generating means also generate the forces to guide the valve body from an excursion position back again into the sealing position. The force, which is exerted by the force-generating means onto the valve body, is predetermined such that the valve body can be shifted with the air bag full or empty through the over- or underpressure in the respiratory air channel from the sealing position into an opening position.

The force-generating means are advantageously magnetic elements. On the one hand, at least one structural component of a magnetic material is disposed in the valve body, on the other hand, in the housing part of the valve at least one structural component for generating a magnetic field or at least one structural component of a magnetic material is installed. The structural components for generating the desired magnetic forces are disposed in the sealing position of the valve body approximately in a common radial plane with respect to the longitudinal axis of the air passage volume. The structural component for generating a magnetic field in the housing part of the valve is usefully formed by a permanent magnet or by an electromagnet whose magnetic field can be regulated by varying the current. The use of magnetic fields for generating the necessary holding and reset forces has the great advantage that the forces can be transmitted onto the valve body free of contact. The entire construction of the valve configuration becomes very simple since no additional force transmission elements are necessary. In addition, the magnetic structural components or the structural components for generating a magnetic field can be installed entirely encapsulated such that a reliable cleaning and, if necessary, also the sterilization of the structural components in contact with respiratory air is possible. The sole movable structural component in this configuration is the valve body with the piston which is freely displaceable in the air passage volume of the respiratory air channel.

Further advantages comprise that the use of the magnetic elements as force-generating means allows several advantageous embodiments. It is possible to install in the valve body a structural component of a magnetically hard material, for example a permanent magnet, and to install in the housing part of the piston valve an annular structural component of a magnetically soft material, for example iron. But it is also possible to employ in the valve body a structural component of a magnetically soft material, for example iron, and to utilize in the housing part of the piston valve one or several structural components of magnetically hard material, for example permanent magnets. An especially compact solution is obtained if in the valve body as well as also in the housing part of the piston valve the magnetic elements consist of a magnetically hard material, for example in both cases of permanent magnets. In this case, in the housing part of the valve or in the proximity of the housing part two structural components of magnetically hard material are usefully installed, with these structural components being symmetrically opposite with respect to the longitudinal axis of the air passage volume. An essential advantage of all of these embodiments comprises that the magnetic elements or their pole configurations and the predetermined strength of the magnetic field make possible a more precise positioning of the valve body in the sealing position and specifically with the desired retaining force. During the opening or displacing of the valve body from the sealing position into an opening position forces staying constant over the opening path or decreasing act onto the valve body such that a very rapid complete opening of the air passage volume in the valve is possible. This is in contrast to the known spring-loaded diaphragm valves or flexible tongue valves in which the opening movement is opposed by a progressively increasing force. The valve configuration according to the invention therefore permits a more precise determination and delimitation of the air volume, which is exhaled additionally to the content of the bag volume, from the training device or which is inhaled into the training device and consequently into the lung of the training person.

The inventive utilization of a piston valve makes it possible to integrate the housing part of the piston valve integrally into the respiratory air channel, meaning to combine all structural components which are in contact with respiratory air, in a single structural component. This structural component, namely the respiratory air channel is retained detachably in a shell housing and specifically such that it can be removed and cleaned in simple manner. Since the valve body is guided freely in the respiratory air channel, it can be removed from it in simple manner and all of these structural components can be cleaned in extremely simple manner. They usefully are comprised of a material which is resistant to sterilization processes.

In the shell housing in which the respiratory air channel is detachably retained, the structural components of magnetic material or the structural components for generating a magnetic field are also usefully disposed which are assigned to the housing part of the piston valve as well as sensors for determining the position of the valve body. This shell housing comprises also a handle for the holding of the training device as well as the transmission members for the data determined by the position sensors and potential further devices. Since the shell housing does not come into contact with the respiratory air, it does not need to be sterilizable and its form can also be shaped within a broad range, since the requirements made of the ability of being cleanable are significantly lower.

The training device according to the invention can be applied for two different training variants of respiration. Namely, for endurance training or for force training. In endurance training one works with the respiratory frequency and the depth of breathing. In force training the resistance, which is put up in opposition to the respiratory processes, is varied. For this purpose the force-generating means in the proximity of the housing part of the piston valve are exchangeable and electromagnets are utilized whose current supply is regulatable. By utilizing means of different strength for force generation, the opening force of the piston valve can be changed. This leads to the result that the force generated by the respiration for opening the valve is also changed. The same effect has changing the magnetic field when using electromagnets.

When using an electromagnet in the proximity of the housing part of the piston valve, the additional advantage is obtained that this valve configuration can be equipped such that it is switchable. For this purpose the electromagnet is linked to a control device. In this case, this control device controls the opening and closing of the piston valve as a function of the predetermined respiratory frequencies or breathing cycles.

A further advantageous solution results if as the force-generating means resilient elements are employed. In this case at least one resilient element is connected, on the one hand, with an end region of the valve body and, on the other hand, with the housing part of the piston valve or the respiratory air channel. With this configuration also, a simplified constructional formation is obtained compared to the known solution and the advantages of the freely movable valve body with the piston are retained. As resilient elements can be utilized in known manner flat coil springs and these are developed such that they can be removed with the valve body in simple manner and be cleaned.

For specific application cases it can be useful to provide two parallel acting piston valves and to assign to one of the valves the inhalation function and to the other the exhalation function. The first piston valve in this case regulates the quantity of consumed air flowing out of the respiratory air channel, and the second of the piston valves regulates the quantity of fresh air flowing into the respiratory air channel. When using one as well as also two piston valves, the displacement path of the valve body is advantageously delimited by end stops. These end stops determine the opening positions of the piston valve for the outflow of consumed air from the respiratory air channel and for the inflow of fresh air into the respiratory air channel.

Further advantages are obtained through the sensors disposed in the housing part of the piston valve or in the shell housing, which serve for determining the position of the valve body in the air passage volume. By means of these sensors is determined whether or not the valve body is located in one of the opening positions and the point in time is detected at which the piston valve is open. The opening times of the piston valve are monitored and registered and serve for monitoring the correct ratio between the respiratory air volume in the bag and the respiratory air flowing out or flowing in via the piston valve.

When using a magnetic element of the type according to the invention in the valve body, it is useful to install in the housing part of the piston valve or in the shell housing on both sides of the sealing position of the valve body in each instance one Hall sensor as the sensors. These Hall sensors respond in known manner to changes of the magnetic field through movements of the valve body in the direction of the longitudinal axis of the air passage channel and consequently can generate corresponding position signals. The Hall sensors can be replaced in a manner known per se by reed sensors, optical sensors or pressure sensors. The sensors are connected with a measuring transducer and, via an interface and a data line, with a control device. The term control device has to be interpreted in the broadest sense and comprises for example also the use of a computer. This control device includes for example an input unit for target data of the respiratory training, a microprocessor, a data store and at least one indicator device for control and check information. The desired limit values or control values for the breathing cycles are preset via this control device. By comparison with the measured data of the sensors disposed in the proximity of the valve configurations, the breathing activities of the person are determined, who utilizes the training device and these data are compared with the target data. In the event of discrepancies from the target data, the control device automatically determines the necessary corrections and indicates these via the indicator device. The person utilizing the training device must subsequently change his breathing processes, especially the frequency and/or depth of breathing, until these coincide with the target data. If the discrepancies exceed a predetermined degree, an alarm function is triggered via the control device, since in this case the CO₂ contents in the inhaled and the exhaled air no longer correspond to the target values. Since in this utilization according to the invention of at least one piston valve, the open-positions and therewith the opening times of the valve body as well as therefrom the ratios of moved air volumes to one another can be precisely determined, the disposition of a CO₂ sensor is not necessary. Thereby an additional simplification of the training device is attained and also the handling by the person training or to be treated is simplified. Due to the specific formation of the valve body, the training device is relatively insensitive with respect to position and facilitates the handling in this respect also.

When the breathing training device according to the invention is utilized by a person for therapeutic purposes or for training the breathing function, individual presettings specific to this person must be fixed. These rest on experience values. First, the vital capacity is measured and from it the bag volume desired for the training is determined. In the standard case the bag volume corresponds to 50% of the volume of the vital capacity. Additional data for determining the bag volume are known from WO 9917842 and are also applied here. Based on experience values for a so-called respiratory minute volume, a correction factor for the training status of the involved person and the bag volume the respiratory frequency must now be calculated. The product of the two factors ‘training status’ and ‘respiratory minute volume’ is divided by the bag volume. With respect to this, more precise data can also be found in WO 9917842 and can be applied supplementarily. During the training the involved person breathes through the training device, and during the inhalation first a portion of the respiratory air volume is removed from the air bag and subsequently with the bag emptied, a portion of the air volume is supplied from the ambient air via the valve configuration. The valve configuration is therein opened by the underpressure generated through the inhalation process in the respiratory air channel. When changing from inhalation to exhalation process, the valve configuration closes and, first, a portion of the air volume is supplied to the air bag and stored therein. After the bag is filled, due to the exhalation process, an overpressure develops in the respiratory air channel and the valve configuration is opened again and a portion of the exhaled air is output via it to the ambient air. Since the respiratory frequency and the bag volume are dependent on one another, the CO₂ content in the respiratory air is kept approximately constant via these device functions or inhalation cycles. This prevents hyper- or hypoventilations from occurring. It is especially advantageous if the respiratory frequency is preset as a target value to a control device. By control devices are understood devices which have available at least a microprocessor or, for example, a computer. Via the control device, or its processor, from the preset respiratory frequency the length of time for one inhalation or one exhalation cycle each is determined. The length of the opened state of the valve configuration is measured on the valve configuration and the corresponding measured values are transmitted to the control device. By comparing the calculated cycle length of the inhalation or exhalation process and the opening length of the valve configuration, a ratio value is determined and compared with a preset stored value. This preset stored value is known from experience curves, which had been determined at approximately constant CO₂ content of the respiratory air. If the calculated value of the ratio differs from the stored and preset value, the control device generates via a display device a correction and/or alarm display and the person utilizing the trainings device must adapt his breathing processes to the values preset by the device. For the average trained persons, it is advantageous to fix the ratio of calculated cycle length of inhalation or exhalation process and the opening duration of the valve configuration to approximately 2:1. If force-generating means are employed on the valve configuration, for positioning the valve body in the valve configuration, which means are regulatable or controllable, the further advantage results that corrections of the breathing processes can also be carried out via the regulation of the opening times of the valve configuration. The desired opening times of the valve configuration are preset on the control device which generates corresponding control pulses for the force-generating means. As a function of these control pulses the force-generating means carry out the corresponding opening and closing processes of the valve configuration, which subsequently are only partially or not at all affected by over- or underpressure in the respiratory air channel. This formation of the training device and the corresponding control presettings are provided especially for application under expert supervision in order for the maintenance of the correct respiratory data to be ensured.

In the following the invention will be explained in further detail in conjunction with embodiment examples with reference to the attached drawing. Therein depict:

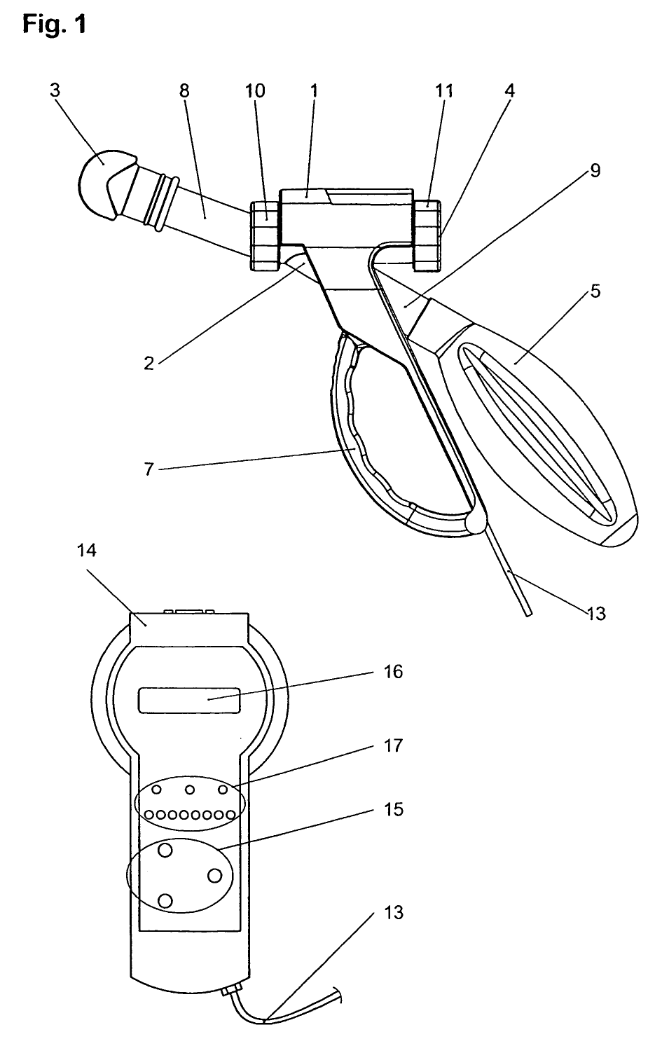

FIG. 1 overall view of the training device according to the invention for the breathing function and of the associated control device,

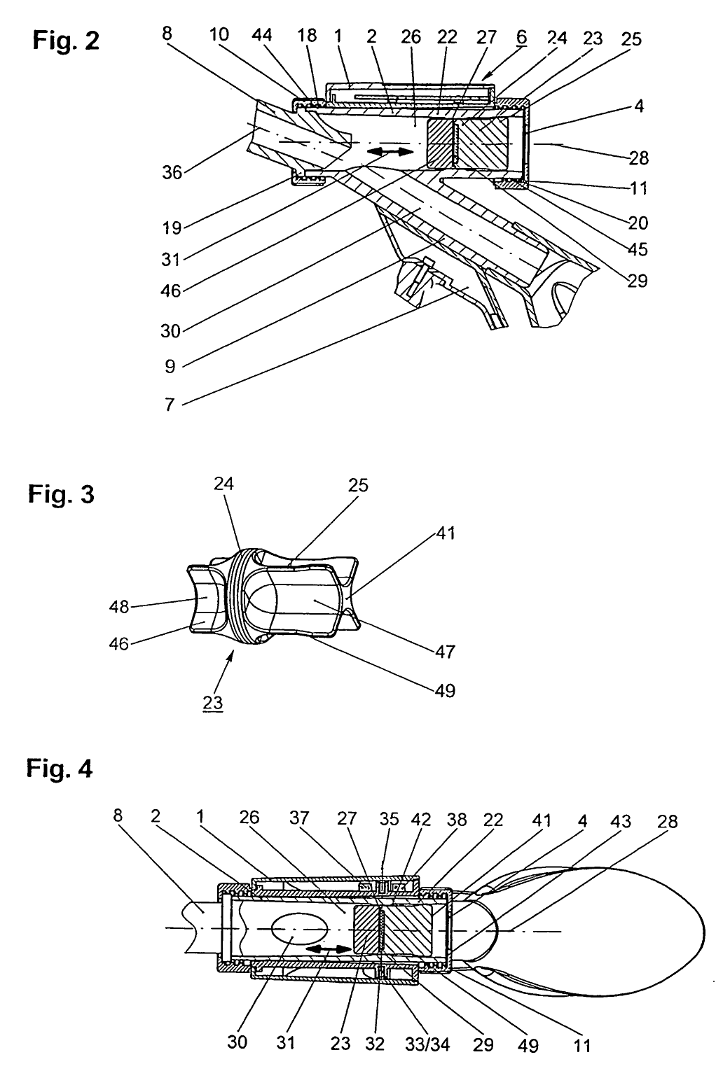

FIG. 2 longitudinal section through the respiratory air channel in the training device with the piston valve,

FIG. 3 perspective view of the valve body of the piston valve,

FIG. 4 cross section through the respiratory air channel of the training device,

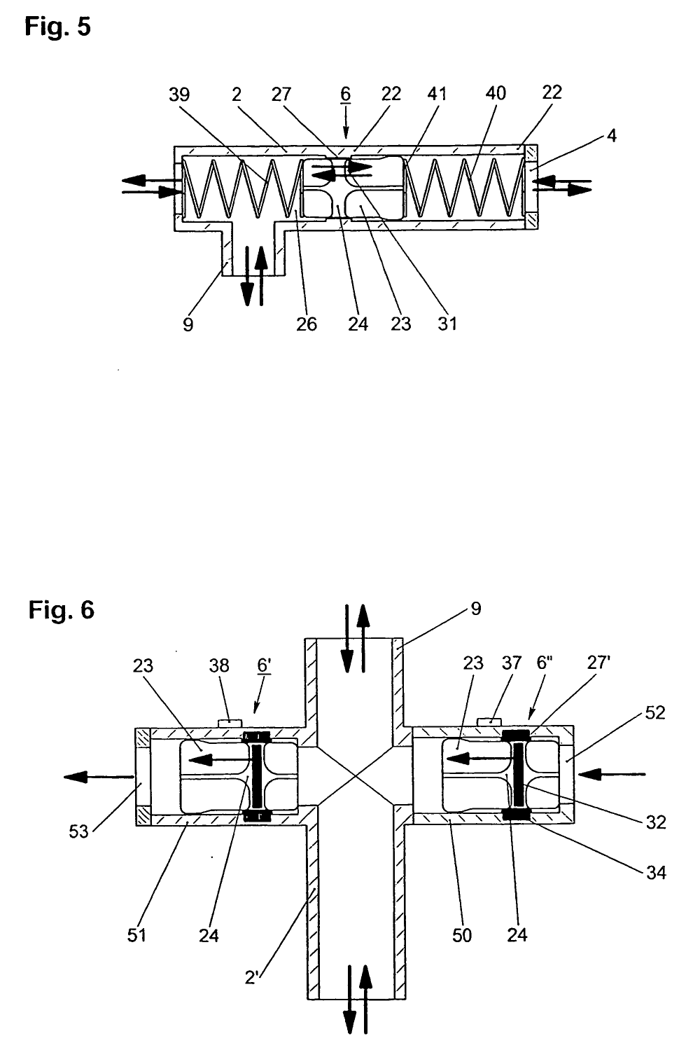

FIG. 5 cross section through a valve configuration shown schematically with springs as force-generating means, and

FIG. 6 cross section through a schematic depiction of a respiratory air channel with two piston valves.

In the representation according to FIG. 1 the entire training device for the breathing function is shown. It comprises essentially a shell housing 1, a respiratory air channel 2 set into this shell housing 1, a mouthpiece 3, which is connected via a connection tube 8 with the respiratory air channel and an air bag 5. Via a cable or a data line 13 the training device is connected with a control device 14. In the depicted example the control device 14 includes a processor and data store, but which can also be part of a portable or stationary computer connected with the control device. The shell housing 1 has a handle 7 with which the training device can be held manually in the required and desired manner. When the training device is utilized, the mouthpiece 3 is taken into the mouth by the person who employs the device for training or therapeutic purposes, and after the respiratory passage through the nose is closed, breathing takes place entirely via the training device. The respiratory air flows via the connecting tube 8 into the respiratory air channel 2. This respiratory air channel 2 has the form of a Y and branches into two channels, with one branch tube 9 leading to the air bag 5 and the respiratory air channel 2 proper to an inlet and outlet opening 4 for respiratory or fresh air. In the respiratory air channel 2 a valve configuration 6 is disposed, which is described in further detail in FIGS. 2 to 4. The air bag 5 is detachable via a connection element 12 and connected with the branch tube 9 and air bags 5 with different volumes are available which are used depending on the pulmonary vital capacity of the training person. During a breathing cycle, which starts for example with an exhalation process, the valve configuration 6 first closes the inlet and outlet opening 4 such that initially the flexible air bag 5 is filled with exhaled air. As soon as the air bag 5 is full, an overpressure develops in the respiratory air channel 2 and the valve configuration 6 opens the throughflow of respiratory air to the inlet/outlet opening 4. The remaining portion of exhaled air now flows via this outlet opening 4 into the ambient air. During the adjoining inhalation process the valve configuration 6 is first closed again and therefore first the respiratory air contained in the air bag 5 is again inhaled. As soon as the air bag 5 is empty again, in the connecting tube 8 and in a portion of the respiratory air channel 2 an underpressure is generated, which opens the valve configuration 6. For the remaining inhalation cycle now fresh air is inhaled via the inlet opening 4. Subsequently these processes repeat cyclically for each breathing cycle. These processes and the training or therapeutic effects resulting therefrom are described in detail in the international patent application WO 9917842 cited as prior art and in the publication Vierteljahresschrift der naturforschenden Gesellschaft, Zürich (1997) 142/4, pp. 153-159. To be able to carry out the desired training or therapeutic processes correctly, the respiratory frequency per minute is preset via the control device 14 and its input unit 15. The breathing processes to be carried out effectively by the training person are indicated in the depicted example on an indicator element 17 and on a second indicator element 16, which is developed as a display, voice outputs are displayed, for example correction or error comments. In the case of breathing process by the training person, which diverge from the from the preset data beyond a permissible discrepancy, the control device 14 or its display elements 16, 17 indicates alarm signals. To ensure the correct operation of the training device, first the vital capacity of the lung of the person training or to be treated therapeutically must be determined in known manner. The volume of the air bag 5 to be used and the breathing frequency, at which the person is to breath, must subsequently be calculated or determined with the aid of tables. The particular training status and the desired course of training must therein be taken into consideration. For normal training processes bags 5 with volumes from 0.51 to 3.5 l in 0.5 l steps are made available. For example, for a well trained male in this case the following results. The vital capacity is determined to be 5 l and therefrom the volume of the air bag 5 at 50% of the vital capacity is obtained as 2.5 l. The respiratory minute volume depends on height and weight and is, for example 150 l. The calculated respiratory frequency in this case is between 20 and 24 cycles/min.

FIG. 2 shows a longitudinal section through the upper region of the shell housing 1 and the respiratory air channel 2 set therein with the valve configuration 6. According to the invention the valve configuration is a piston valve 6, which has considerable advantages compared to the known valves. The respiratory air channel 2 is detachably set into the shell housing 1 and is detachably fastened by means of the connecting element 10 and the closure element 11 in the shell housing 1. The connecting element 10 is disposed on that side at which the connecting tube 8 for mouthpiece 3 is disposed. On the respiratory air channel 2 outer threads 18 are disposed and the connecting element 10 has inner threads 44. The connecting tube 8 is connected by means of the connecting element 10 with the respiratory air channel 2 via a sealing ring 19 which simultaneously forms a retaining shoulder. The respiratory air channel 2 is developed in the form of a Y and comprises an air passage volume 26 and a flow channel 30 branching off therefrom. As already described, the flow channel 30 leads to the air bag 5, which is connected across the connecting element 12 with the branch tube 9 of respiratory air channel 2. In the portion of the respiratory air channel 2 facing away from the connecting tube 8 the piston valve 6 is disposed following the branching-off of the flow channel 30. This piston valve 6 is comprised of a housing part 22, which forms an integral component of the respiratory air channel 2. On the shell of the air passage volume 26 in the proximity of the housing part 22 a sealing face 27 is disposed which extends only over a subregion in the direction of the flow axis 28, in the depicted example for example over 9 mm, and the diameter of the air passage volume 26 in the region of the sealing position is approximately 23 mm. In front of and behind this sealing face 27 the air passage volume 26 has a greater cross section than in the sealing region. In the proximity of housing part 22 a valve body 23 is set into the air passage volume 26. This valve body comprises a piston 24 and a guide part 25 as well as 46. The valve body 23 is slidingly guided via the piston 24 and the guide part 25 in the air passage volume 26 of the respiratory air channel 2 and freely movable in the direction of arrow 31. The movement of the valve body in the direction of arrow 31 or in the direction of the flow axis 28 in the air passage volume 26 is delimited by end stops 42, 43 shown in FIG. 4. The installation and removal of the valve body 23 takes place from that side of the respiratory air channel 2 on which the inlet/outlet opening 4 is disposed. For that purpose on the respiratory air channel 2 at its end region outer threads 20 are disposed which cooperate with inner threads 45 on closure element 11. In the example depicted in FIG. 2 the flow axis 28 of the air passage volume 26 in the region of the piston valve 6 coincides with the longitudinal axis 36 of respiratory air channel 2. By removing the connecting element 10 and the closure element 11 as well as connecting element 12 the various structural components of the training device can be separated from one another in simple manner. The respiratory air channel 2 is formed simply and does not have any complicated formed elements, which can only be cleaned with difficulty or not at all. The valve body 23 is also formed such that it can be cleaned optimally. This applies also to the other structural components which come into contact with respiratory air, namely the mouthpiece 3, the connecting tube 8 and, for example, the closure element 11. All of these structural components can be produced of a material which, if necessary, is sterilizable. The installation and removal of the valve body 23 can take place in extremely simple manner, since it does not have a direct mechanical connection to the housing part 22 or respiratory air channel 2. This leads to considerable simplification of the cleaning and handling of the device. The configuration according to the invention makes it possible for any person utilizing the training device to associate those parts which are contaminated with respiratory air specifically, i.e. specific to the person.

The shell housing 1 and the control device 14 can be utilized by different, i.e. several, persons, since it does not come into contact with respiratory air. In normal cases superficial cleaning is sufficient. This formation according to the invention makes possible a cost-effective utilization of such respiratory training devices, especially in therapeutic use, where several different persons are treated successively. For a new utilization of the respiratory training device all parts which come into contact with respiratory air can be exchanged in simple manner and the device is immediately available again.

FIG. 3 shows a valve body 23 according to the invention, which is a component of the piston valve 6. Adjoining piston 24 is, on the one hand, the guide part 25 and, on the opposing side, the guide part 46. The two guide parts 25 and 46 comprise essentially 4 symmetrically disposed ribs, between which flow channels 47, 48 for the air are located. In the end region 41 of guide part 25, facing away from piston 24, the guide part 25 has a greater diameter than the piston 24. Between piston 24 and end region 41 the diameter of the ribs of guide part 25 is reduced and stop faces 49 are developed. The diameter of the ribs of the guide part 46 is also reduced relative to piston 24.

FIG. 4 shows a cross section through respiratory air channel 2 along axis 36 according to FIG. 2. In this representation the force-generating means 29 are shown which retain the valve body 23 in the sealing position or determine the opening forces for the piston valve 6 and is disposed in the proximity of the housing part 22. In the depicted example the force-generating means 29 are comprised of magnetic elements and the valve body 23 includes a structural component 32 of a magnetic material and in the proximity of the housing part 22 of valve 6 means with two structural components 34 of a magnetic materials are disposed. In the sealing position of valve body 23 these magnetic elements 32, 34 are positioned in a common radial plane 35 with respect to the flow axis 28 of the air passage volume 26. The two structural components 34 are permanent magnets, i.e. magnetic elements of a magnetically hard material. The magnetic structural component 32 in valve body 23 is also formed by a permanent magnet or is comprised of a magnetically hard material. The axes of the magnetic elements 32 and 34 extend approximately parallel to the flow axis 28 and the pole configurations are oriented identically aligned. The two magnetic structural components 34 are disposed in the shell housing 1 symmetrically to the flow axis 28 and abut the housing part 22 of piston valve 6. Through the magnetic field generated by the two magnetic elements 34 the magnetic structural component 32 is positioned in the piston 24 or valve body 23 approximately in plane 35 and therewith the valve body 23 is held in the sealing position. The effective magnetic forces are determined in known manner such that the valve body 23 is only displaced at a desired under- or overpressure in the direction of arrow 31 from the sealing position. But it is also possible to employ in the shell housing 1 or in the proximity of the housing part 22 of piston valve 6, instead of permanent magnets 34, electromagnets 33, which are activated by electric current. The appropriate current supply and control signal supply is carried out from the control device 14 via the cable 13 and further, not shown, connection lines in shell housing 1. This configuration permits changing the opening forces for opening the valve as can be useful in force training. But, furthermore, the advantage also results that the valve opening times can also be affected and controlled from the control device. This can be desirable with the professional application of the device. A further embodiment comprises that in the valve body 23 the magnetic element is formed of a permanent magnet 32 and in the housing part 1 the magnetic elements are formed of a magnetically soft material, for example iron, and usefully an annular element can be utilized. The same configuration is also possible conversely in that the magnetic structural component 32 in the valve body 23 is comprised of a magnetically soft material, for example iron, and the two magnetic structural components 34 in the proximity of the valve housing 22 are comprised of a magnetically hard material, i.e. of a permanent magnet. All of these configurations meet the desired functions according to the invention. On both sides of the sealing position between piston 24 and sealing face 27 on housing part 22 two sensors 37, 38 are disposed spaced apart from the sealing plane 35 in shell housing 1. In the depicted example these are Hall sensors, by means of which changes of the magnetic field can be detected which are generated with the displacement of the valve bodies 23 or its magnetic structural component 32. The same functions can also be acquired by reed sensors, optical sensors or pressure sensors. By means of these sensors 37 or 38 it is possible to detect whether or not the valve body 23 is located in the opening position for the inhalation of fresh air or in the opening position for the ejection of respiratory air through opening 4. The opening position for the inlet of fresh air through opening 4 is determined by a stop 42 at the end of sealing face 27 and a stop 49 on the ribs of guide part 25. This opening position and the length of time of the opening is detected via the sensor 37. The opening position of the valve body 23 for the outlet of consumed air through opening 4 is determined by the end region 41 on guide part 25 and the inner face on closure element 11, which forms an end stop 43. To this opening position is assigned the sensor 38, which detects the opening status and the length of time of the opening. In these movements in the direction of the arrow 31 from the sealing position into the particular opening position, the valve body 23 slides in the air passage volume 26, with this sliding movement generating only very low friction losses. The configuration according to the invention has the advantage that the necessary forces for excursion from the sealing position into the opening position do not progressively increase the further the excursion of the body, but such force rather either stays constant or decreases. The advantage resulting therefrom that the valve body 23 upon exceeding the holding force in the sealing position is immediately completely displaced into the opening position and therewith the entire throughflow cross section for the air is released. Therewith the throughflow quantity of air is sufficiently determined with sufficient precision by the opening times of the piston valve 6 and no additional sensors for determining the CO₂ content of the air are necessary.

FIG. 5 shows essentially the respiratory air channel 2 and the piston valve 6 in schematic representation. The shell housing 1 and the remaining attachment parts are not shown. Here too the housing part 22 of piston valve 6 is an integral component of the respiratory air channel 2. The housing part 22 comprises the sealing face 27 and on valve body 23 the piston 24 is correspondingly disposed. The formation of valve body 23 and sealing face 27 corresponds to the embodiments according to FIGS. 3 and 2. The force-generating means 29 in this embodiment example are, however, not formed by magnetic elements but rather by the two flat coil springs 39 and 40. The forces of these two flat coil springs 39 and 40 retain the valve body 23 in the sealing position and permit a displacement in the direction of the two arrows 31. Therewith the same operational function as described in FIGS. 1 to 4 results. This embodiment can be applied in specific cases, where a device as cost-effective as possible is desired and also a progressive increase of the opening forces on the valve body 23 can be tolerated, i.e. a device with a lower operating precision is permitted. The advantages of the piston valve according to the invention are nevertheless retained.

The training device according to the invention can also be equipped with two piston valves 6′ and 6″ as is also shown in FIG. 6 schematically. A respiratory air channel 2′ comprises two laterally branching tube pieces 50, 51, which each have at their outer end an inlet opening 52 or an outlet opening 53. The respiratory air channel 2 also has a branch-off tube 9 leading to the air bag 5. In each of the two tube pieces 50, 51 a valve body 23 is disposed whose embodiment corresponds to the valve body according to FIG. 3. The two valve bodies 23 comprise a piston 24, in which a magnetic structural component in the form of a permanent magnet 32 is installed. On the inner shell of tube pieces 50, 51 the necessary sealing face 27′ is disposed which cooperates with piston 24. In the proximity of the sealing face 27′ in the tube pieces 50 and 51 two diametrically opposing magnetic structural components in the form of permanent magnets 34 are installed. The two valve bodies 23 in this formation can only be displaced from the sealing position in one direction into an opening position.

The valve 6″ in tube piece 50 has the function of drawing in fresh air via the opening 52. The opening position of the valve body 23 is detected via the sensor 37 and also the opening time is determined. Valve 6′ in tube piece 51, in comparison, has only the function of making possible the outlet of consumed air through opening 53 and specifically if the air bag 5 is filled. Here also the opening position and the opening time of the valve body 23 is determined via the sensor 38. This configuration with two piston valves 6′ and 6″ makes it possible to fix different opening points in time for the drawing-in of fresh air or the opening time point for the outlet of respiratory air into the environment. This can be useful and of interest for certain training and/or therapy programs.

In the method according to the invention for monitoring the fresh air supply on the respiratory training device basic data are partially used, which were determined in experimental series on test subjects. Especially the vital capacity depends on the person and the respiratory limit value depends on the person and on the sex. For the determination by calculation of the respiratory frequency of a specific person the following approach is necessary. First, in known manner, the vital capacity (Vc) is measured. The volume of the air bag 5 is fixed such that it is 50% of the vital capacity. Additionally, the respiratory limit value (MVV) is determined and specifically according to the following function:

Men: MVV=(1.193×height)−(0.816×age)−37.949

Women: MVV=(0.0842×height)−(0.685×age)−4.868

Height must be stated in cm and age in years.

For endurance training a respiratory minute volume (AMV) is recommended, which is 60% of the respiratory limit value (MVV).

Determining the respiratory frequency (1/min) is carried out according to the function respiratory frequency+AMV/1.5×bag volume.

If training takes place in the range of these values, it is ensured that the training person does not have too much CO₂ (hypocapnic) or too little CO₂ (hypercapnic) in the respiratory air. Depending on the fixing of the limit values for the CO₂ content in the respiratory air, constants adapted in the formulas are inserted. These functions and table values apply to healthy average persons. For untrained persons, other person groups or, for example, ill persons, individual clarifications and adaptations are necessary.

1. Training device for respiratory function with a mouthpiece (3), a respiratory air channel (2) adjoining the mouthpiece (3) with an inlet/outlet opening (4) for air, a flexible air bag (5) connected with the respiratory air channel (2) and a valve configuration (6) for regulating the outlet quantity of consumed air from the respiratory air channel (2) and the inlet quantity of fresh air into the respiratory air channel (2), characterized in that the valve configuration comprises at least one piston valve (6) and this piston valve (6) comprises a housing part (22) with an air passage volume (26) and a sealing face (27) disposed on the shell of this air passage volume (26), in the air passage volume (26) of the housing part (22) a valve body (23) is disposed and this valve body (23) is slidingly guided in the air passage volume (26) and is freely displaceable in the direction of the flow axis (28) of the air in the air passage volume (26) from a sealing position into a position, in which at least a partial cross section of the air passage volume (26) is open, this valve body (23) comprises a piston (24) with an outer sealing region and a guide part (25) for the sliding guidance in the air passage volume (26), and the sealing region of the piston (24) in the sealing position of the valve body (23) cooperates with the sealing face (27) on the shell of the air passage volume (26) and closes the cross section of the air passage volume (26) and force-generating means (29) for positioning the valve body (23) in this sealing position are available.

2. Training device as claimed in claim 1, characterized in that the force-generating means (29) are magnetic elements, the valve body (23) comprises at least one structural component (32) of a magnetic material and in the proximity of the housing part (22) of valve (6) at least one structural component (33) for generating a magnetic field or at least one structural component (34) of a magnetic material is disposed, and these parts (32, 33/34) in the sealing position of the valve body (23) are approximately in a common radial plane (35) relative to the flow axis (28) of the air passage volume (26).

3. Training device as claimed in claim 2, characterized in that the structural component for generating a magnetic field in the housing part (22) of the piston valve (6) is a permanent magnet (34) or an electromagnet (33).

4. Training device as claimed in claim 2, characterized in that the structural component (32) of magnetic material in the valve body (23) comprises a magnetically hard material, for example a permanent magnet and in the housing part (22) of the piston valve (6) an annular structural component (34) of a magnetically soft material, for example iron, is disposed.

5. Training device as claimed in claim 2, characterized in that the structural component (32) of magnetic material in the valve body (23) comprises a magnetically soft material, for example of iron, and the structural component (34) of magnetic material in the housing part (22) of the piston valve (6) is comprised of a magnetically hard material, for example, a permanent magnet.

6. Training device as claimed in claim 2, characterized in that the structural component (32) of magnetic material in the valve body (23) and the structural component (34) of magnetic material in the housing part (22) of the piston valve (6) is comprised of a magnetically hard material, for example a permanent magnet.

7. Training device as claimed in claim 2, characterized in that in the housing part (22) of valve (6) at least two structural components (34) of magnetically hard material, in particular permanent magnets, are installed and these structural components (34) are disposed symmetrically about the longitudinal axis of the air passage volume (26).

8. Training device as claimed in claim 1, characterized in that the housing part (22) of the piston valve (6) is unitarily integrated into the respiratory air channel (2), the flow axis (28) of the air passage volume (26) extends approximately in the direction of the longitudinal axis (36) of the respiratory air channel (2) and this respiratory air channel (2) is detachably retained in a shell housing (1).

9. Training device as claimed in claim 8, characterized in that the respiratory air channel (2) and the housing part (22) of the piston valve (6) as well as the valve body (23) are comprised of a material which is resistant against sterilization processes.

10. Training device as claimed in one of claims 1 to 9, characterized in that the structural components (34) of magnetic material or the structural components (33) for generating a magnetic field, which are associated with the housing part (22) of piston valve (6) as well as sensors (37, 38) for determining the position of the valve body (23), are disposed in a shell housing (1) and the respiratory air channel (2) and the housing part (22) for the piston valve (6) with the valve body (23) are detachably set into this shell housing (1) and are fastened therein.

11. Training device as claimed in one of claims 1 to 9, characterized in that the force-generating means (33, 34) in the proximity of the housing part (22) of the valve (6) are exchangeable and means (33, 34) with different force generation are insertable.

12. Training device as claimed in claim 1, characterized in that the force-generating means (29) are resilient elements (39, 40) and at least one such resilient element (40) is connected, on the one hand, with an end region (41) of the valve body (23) and, on the other, with the housing part (22) of the piston valve (6).

13. Training device as claimed in claim 2 or 12, characterized in that the valve configuration comprises two parallel acting piston valves (6′, 6″), and a first of the piston valves (6′) serves for the control of the outlet quantity of consumed air from the respiratory air channel (2′) and a second of the piston valves (6″) for the control of the inlet quantity of fresh air into the respiratory air channel (2′).

14. Training device as claimed in one of claims 1 to 7 or 12, characterized in that the displacement path of the valve body (23) in the air passage volume (26) is delimited by two end stops (42, 43), and each of these end stops (42, 43) in the direction of the flow axis (28) has a given spacing relative to the sealing position of the valve body (23) in the housing part (22) and a first stop (43) determines the opening position of the piston valve (6) for the outlet of consumed air from the respiratory air channel (2) and the second other stop (41) the opening position of the piston valve (6) for the inlet of fresh air into the respiratory air channel (2).

15. Training device as claimed in one of claims 1 to 7 or 12 or 13, characterized in that in the housing part (22) of the piston valve (6) and in the displacement range of the piston (24) of the valve body (22) at least one sensor (37, 38) for determining the position of the valve body (22) in the air passage volume (26) is disposed.

16. Training device as claimed in claim 15, characterized in that in the housing part (22) on each of the two sides of the sealing position of the valve body (22) one Hall sensor (37, 38) is installed, and these two Hall sensors (37, 38) generate signals due to changes of the magnetic field through the movements of the valve body (23) in the direction of the flow axis (28) of the air passage channel (26).

17. Training device as claimed in claim 15, characterized in that the sensor (37, 38) is connected to a measuring transducer and this measuring transducer is connected across an interface and a data line (13) with a control device (14).

18. Training device as claimed in claim 17, characterized in that the control device (14) comprises an input unit (15) for target data of the respiratory training, a microprocessor, a data store and at least one display element (16, 17) for control and check information.

19. Training device as claimed in claim 2, characterized in that the structural component for generating a magnetic field in the proximity of the housing part (22) of the piston valve (6) is an electromagnet (33) and this electromagnet (33) can be switched on and off via a control device (14).

20. Method for monitoring the fresh air supply on a training device for the respiratory function according to claim 1, when used by a person in which during inhalation first a portion of the air volume is removed from an air bag (5) and subsequently, with the bag (5) empty, a portion of the air volume is supplied via a valve configuration (6) from the ambient air and stored therein and after the bag is filled, a portion of the exhaled air is output via the valve configuration (6) to the ambient air and before starting the training a bag volume is determined specific to a person as well as a respiratory frequency specific to the person is calculated and this respiratory frequency across an input unit (15) in a control device (14) is preset in a processor as a target value, is characterized in that the processor determines the length of time for an inhalation or exhalation cycle, the length of the opened state of the valve configuration (6) during each inhalation and exhalation cycle is measured and transmitted as measured value to the processor, the ratio between calculated cycle length of the inhalation or exhalation process and the opening length of the valve configuration (6) is determined and compared to a person-specific predetermined stored value and in the event discrepancies exist of the measured from the stored value a correction and/or an alarm indication is generated by the processor via a display device (16) and therewith the CO₂ content in the respiratory air is kept approximately constant.

21. Method as claimed in claim 20, characterized in that the ratio of calculated cycle length of the inhalation or exhalation process and the opening length of the valve configuration (6) is fixed to approximately 2:1.

22. Method as claimed in claim 20 or 21, characterized in that the opening times of the valve configuration (6) are predetermined, the control device (14) generates corresponding control pulses and on the valve configuration (6) controllable means (33) carry out opening and closing processes of the valve (6) as a function of these control pulses.
